(19) United States
(12) Patent Application Publication
(10) Pub. No.: US 2019/0310578 A1
(43) Pub. Date: Oct. 10, 2019

(54) IMAGE FORMING SYSTEM, POST-PROCESSOR, AND COMPUTER READABLE RECORDING MEDIUM STORING PROGRAM

(71) Applicant: Konica Minolta, Inc., Tokyo (JP)

(72) Inventor: Yoshifumi WAGATSUMA, Tokyo (JP)

(21) Appl. No.: 16/379,067

(22) Filed: Apr. 9, 2019

(30) Foreign Application Priority Data
Apr. 10, 2018 (JP) 2018-075409

(51) Int. Cl. G03G 15/00; B65H 37/06; B65H 39/10

(52) U.S. Cl. CPC G03G 15/655; B65H 39/10; B65H 37/06

(57) ABSTRACT

An image forming system is configured to execute a printing process to a sheet based on a job for generating output products, and to print index information required for sorting the output products for the respective jobs on a partition sheet. A folding process unit is allowed to designate a folding position of the partition sheet so that at least a part of the index information printed on the respective partition sheets is visible from a predetermined direction.

### CROSS-REFERENCE TO RELATED APPLICATIONS

The present application claims priority under 35 U.S.C. § 119 to Japanese Patent Application No. 2018-075409, filed on Apr. 10, 2018, is incorporated herein by reference in its entirety.

### BACKGROUND ART

### Technological Field

The present invention relates to an image forming system configured to generate output products of the respective jobs while inserting a partition sheet in between the output products of adjacent jobs, a post-processor, and a computer readable recording medium storing a program.

In the recent field of an image forming apparatus such as the electrophotographic copying machine and the laser printer, various devices for automatically executing the post-processing to the image-formed sheet so called the post-processor have been increasingly developed. The post-processed sheets of multiple jobs are discharged to the collection tray so as to be collected. The discharged sheets of the multiple jobs collected on the collection tray will be sorted out by inserting an index sheet in between the sheets of adjacent jobs.

Japanese Unexamined Patent Application Publication No. Hei 10-194578 (Patent Literature 1) discloses the method for sorting out discharged output products of multiple jobs. For example, Patent Literature 1 discloses the image forming system which includes “an image forming unit for forming an image on a sheet through an electrographic process, a sheet folding unit capable of folding the sheet ejected from the image forming unit in two at a position slightly dislocated at least from the center in the conveying direction, a designation unit for designating the position at which the index sheet is inserted in between the image-formed sheets, and a control unit configured to feed and convey the index sheet at the timing designated by the designation unit, and to further control the sheet folding unit to fold the index sheet in two at the position slightly dislocated from the center in the conveying direction”.

### CITATION LIST

### Patent Literature

Patent Literature 1: Japanese Unexamined Patent Application Publication No. Hei 10-194578

### SUMMARY

According to the technology described in Patent Literature 1, the index sheet is folded in two at the position slightly dislocated from the center in the conveying direction so as to automatically generate the document (output product) having one edge of the index sheet protruding from the copy sheet. This makes it possible to easily sort out the documents of the multiple jobs. In order to sort out the collected output products of multiple jobs, the above-disclosed system fails to allow immediate confirmation of the index information list printed on a plurality of partition sheets each inserted in between the output products of adjacent jobs from just above or beside the collected output products.

There has been a specific type of post-processor configured to punch the output products for each job, through which a string is made to pass, and to fold the output products at the specific part for the purpose of sorting out the collected output products of multiple jobs. In the process for folding the specific part, a cut piece formed through the notching process while being not in contact with four sides is folded back so that the fold-back piece protrudes (forming a tab) from the side of the sheet. It is difficult for the image forming apparatus provided with no specific post-processor as described above to execute the process so as to allow immediate confirmation of the printed index information list for sorting out the output products of multiple jobs.

In the above-described circumstances, the immediate confirmation of the index information list printed on the multiple partition sheets each inserted in between the output products of adjacent jobs has been demanded to sort out the discharged output products of multiple jobs without requiring the specific post-processor.

To achieve at least one of the abovementioned objects, according to an aspect of the present invention, an image forming system reflecting one aspect of the present invention includes a conveyor section for conveying a sheet on which a printing process for forming an image is executed based on a job, and conveying a partition sheet in between the jobs, an image forming section for generating an output product by executing the printing process to the sheet based on the job, and printing index information required for sorting the output products for the respective jobs on the partition sheet, a folding process unit capable of making a fold on the partition sheet on which the index information has been printed by the image forming section, a collection tray disposed at a downstream side of the folding process unit in a sheet conveying direction, which is capable of collecting the output products of the jobs generated by the image forming section, and a control section configured to insert the folded partition sheet, on which the index information has been printed in between the output products of the respective jobs to be collected to the collection tray. The control section allows the folding process unit to designate a folding position of the partition sheet so that at least a part of the index information printed on the respective partition sheets each inserted in between the output products of the respective jobs is visible from a predetermined direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a sectional view schematically showing an overall structure example of an image forming system according to a first embodiment of the present invention;

FIG. 2 is a block diagram showing an example of each control system of the respective sections constituting the image forming system according to the first embodiment of the present invention;

FIG. 3 is a front view of a stack section, explaining an example of stacking the output products and inserting the partition sheets according to the first embodiment of the present invention;

FIG. 4 is a flowchart representing an example of a job processing procedure including the folding process and insertion of the partition sheet according to the first embodiment of the present invention;

FIG. 5 is a front view of a stack section, explaining an example of stacking the output products and inserting the partition sheets according to a second embodiment of the present invention;

FIG. 6 is an explanatory view of a process for two-folding the partition sheet according to the second embodiment of the present invention;

FIG. 7 is a front view of a stack section, explaining an example of stacking the output products and inserting the partition sheets according to a third embodiment of the present invention;

FIG. 8A and FIG. 8B are explanatory views showing a process for folding the partition sheet according to the third embodiment of the present invention, wherein FIG. 8A represents a three-folding process, and FIG. 8B represents a Z-folding process;

FIG. 9 is an explanatory view showing an example of a state where two partition sheets are overlapped as described in a fourth embodiment of the present invention;

FIG. 10 is an explanatory view showing index areas of the two overlapped partition sheets as described in the fourth embodiment of the present invention;

FIG. 11 is an explanatory view showing an example of a sheet setting screen; and

FIG. 12 is a flowchart representing an example of a job processing procedure including the folding process and insertion of the partition sheet according to the fourth embodiment of the present invention.

### DETAILED DESCRIPTION OF EMBODIMENTS

One or more embodiments for carrying out the present invention (hereinafter referred to as an “embodiment”) will be described referring to the drawings. However, the scope of the invention is not limited to the disclosed embodiments. Components having functions or structures substantially the same as those of the specification and the drawings will be designated with the same codes, and overlapping descriptions thereof, thus will be omitted.

### 1. First Embodiment

### [Overall Structure of Image Forming System]

An example of an overall structure of an image forming system according to a first embodiment will be described.

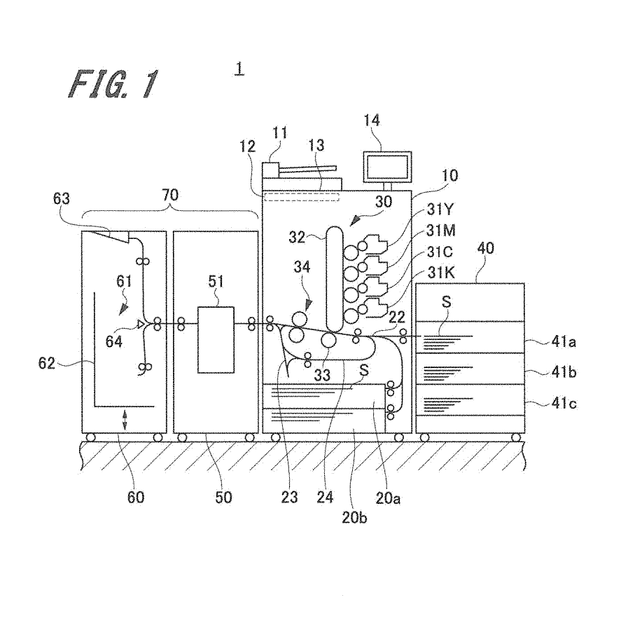

FIG. 1 is a sectional view schematically showing an overall structure example of the image forming system according to the first embodiment.

As FIG. 1 shows, an image forming system 1 includes an image forming apparatus 10, a large-capacity sheet feeding unit 40, a folding process unit 50, and a stack unit 60, which are connected in series. The folding process unit 50 and the stack unit 60 constitute a post-processor 70.

### (Large-Capacity Sheet Feeding Unit)

The large-capacity sheet feeding unit 40 includes a plurality of sheet feed trays 41a to 41c adaptable to size and type of a sheet S. If the sheet feed trays 41a to 41c do not have to be distinguished, those trays will be referred to as sheet feed trays 41. The large-capacity sheet feeding unit 40 allows selection of any one of the sheet feed trays 41 based on the instruction from the image forming apparatus 10. A not-shown sheet feed unit is configured to take the sheet S from the selected sheet feed tray 41, and send the sheet to the image forming apparatus 10. The sheet S may be stored in either sheet feed tray 20a or 20b of the image forming apparatus 10.

### (Image Forming Apparatus)

The image forming apparatus 10 of electrographic type is configured to electrostatically generate an image, for example, as a tandem type color image forming apparatus for superposing four-color toner images of yellow (Y), magenta (M), cyan (C), and black (K). The image forming apparatus 10 includes the sheet feed trays 20a, 20b, a document reader 12, an image forming section 30, an auto document feeder (ADF) 11, and an operation display panel 14. The partition sheet (also referred to as an “index sheet”) is stored in either of the sheet feed trays 20a and 20b. If the sheet feed trays 20a and 20b do not have to be distinguished, they will be referred to as sheet feed trays 20 hereinafter. It is possible to store the partition sheet in any one of the sheet feed trays 41 of the large-capacity sheet feeding unit 40.

The image forming apparatus 10 includes a conveying path 22 for conveying the sheet S which has been fed from the large-capacity sheet feeding unit 40 or the sheet feed tray 20. The conveying path 22 includes a plurality of rollers (conveyor rollers) for conveying the sheet S.

The auto document feeder 11 allows not shown multiple rollers and a conveyor drum to convey documents set on a document feed stand to a reading position of the document reader 12, that is, an upper surface of a platen glass 13 (document stand) one by one. The auto document feeder 11 ejects the document conveyed by a document ejection roller to a document ejection tray of the auto document feeder 11.

The image forming section 30 includes four image forming units 31Y, 31M, 31C, 31K for generating color toner images of yellow, magenta, cyan, black. Each of the respective image forming units includes an electrifying part, an exposure part such as a laser light source, a development part, and a photoreceptor. The image forming section 30 includes an intermediate transfer belt 32 to which the images generated on the photoreceptors of the image forming units 31Y, 31M, 31C, 31K are transferred, a secondary transfer part 33, and a fixing part 34 downstream from the secondary transfer part 33 in the sheet conveying direction.

The conveying path 22 extends to be connected to a conveying path of the folding process unit 50 downstream from the fixing part 34 in the sheet conveying direction. A reversing conveying path 24 connected to the conveying path 22 is branched therefrom downstream from the fixing part 34, and further joins the conveying path 22 upstream from the secondary transfer part 33. The reversing conveying path 24 includes a reversing part 23 for reversing the sheet S. The reversing part 23 reverses the sheet S which has been conveyed from the fixing part 34 so that the sheet is conveyed to the conveying path 22 upstream from the secondary transfer part 33 through the reversing conveying path 24. The reversing part 23 may be configured to return the reversed sheet S to the conveying path 22 downstream from the fixing part 34 so as to be directly conveyed to the folding process unit 50.

The operation display panel 14 is disposed above the image forming apparatus 10. The operation display panel 14 includes a display unit for displaying the information, and an operation unit for receiving an operator's operation. The display unit is constituted as an LCD (Liquid Crystal Display) panel, for example, and displays the screen on which an operation-related proposal is offered to the operator. The display unit may be provided with a multicolor LED for imparting intuitive visual information to the operator. The operation unit is constituted by overlaying a touch panel on the LCD panel for the display unit which is constituted as the touch panel and a button, for example. The operation unit may be constituted as, for example, the mouse, the keyboard, or the tablet separately from the display unit.

The image forming apparatus 10 electrifies each of the photoreceptors of the image forming units 31Y, 31M, 31C, 31K in an image forming mode, and exposes the surface of the photoreceptor in accordance with the document image so that an electrostatic latent image is formed on the photoreceptor. Then the developing part is operated to adhere toners to the respective electrostatic latent images of the photoreceptors corresponding to colors of yellow, magenta, cyan, black so that the toner images in the respective colors are formed. The toner images formed on the photoreceptors for yellow, magenta, cyan, black are sequentially primary transferred onto the surface of the rotatably driven intermediate transfer belt 32.

A secondary transfer part 33 (secondary transfer roller) subjects the toner images in the respective colors which have been primary transferred onto the intermediate transfer belt 32 to the secondary transfer onto the sheet S supplied from the large-capacity sheet feeding unit 40. As the toner images in the respective colors on the intermediate transfer belt 32 are secondary transferred onto the sheet S, the color image is formed. The image forming apparatus 10 ejects the sheet S on which the color toner images are formed to the fixing part 34.

The fixing part 34 executes the fixing process to the sheet S supplied from the image forming apparatus 10, on which the color toner image is formed. The fixing part 34 pressurizes and applies heat to the conveyed sheet S so that the transferred toner image is fixed on the sheet S. The fixing part 34 includes a fixing upper roller and a fixing lower roller each as a fixing member. The fixing upper roller and the fixing lower roller are arranged while being in pressure contact with each other. A fixing nip part is formed as a part in pressure contact with the fixing upper roller and the fixing lower roller.

A heater is disposed inside the fixing upper roller. The radiant heat from the heater warms a roller part on an outer circumference of the fixing upper roller. The sheet S is conveyed to the fixing nip part so that the surface on which the toner image has been transferred by the secondary transfer part 33 (fixing surface) faces the fixing upper roller. The sheet S passing the fixing nip part is pressurized by the fixing upper roller and the fixing lower roller, and heated under the heat of the roller part of the fixing upper roller. The sheet S subjected to the fixing process by the fixing part 34 is ejected to the folding process unit 50.

### (Folding Process Unit)

The folding process unit 50 executes the folding process to the sheet S which has been conveyed from the image forming apparatus 10 based on the job, and conveys the folded sheet S to the stack unit 60. The folding process unit 50 includes a folding processor 51 for executing the folding process to the conveyed sheet S. For example, the folding processor 51 is configured to allow the sheet to be two-folded with a single fold, three-folded with two recessed folds seen from above, and Z-folded with the recessed and projected folds.

### (Stack Unit)

The stack unit 60 is disposed downstream from the folding process unit 50 in the sheet conveying direction, and discharges the sheet S which has been conveyed from the folding process unit 50 to the collection tray 62 or a discharge tray 63 based on the job. The stack unit 60 includes a switching part 64 for switching the path on which the sheet S is conveyed, and a stack part 61. The stack part 61 includes the collection tray 62 capable of collecting the output products of multiple jobs generated by the image forming section 30, and a not-shown drive mechanism configured to vertically move the collection tray 62 in accordance with the number of the sheets S collected on the collection tray 62.

The post-processor 70 may be provided with an additional unit apart from the folding process unit 50 and the stack unit 60. For example, it is possible to configure the post-processor 70 as a unit provided with a post-processing devices such as a sorter for sorting out the sheets S in accordance with the specific rule, a stapler for stapling the sheets S, and a puncher for punching the sheets, which is disposed between the image forming apparatus 10 and the stack unit 60.

### [Control System of Image Forming System]

Control systems of the respective units constituting the image forming system 1 will be described.

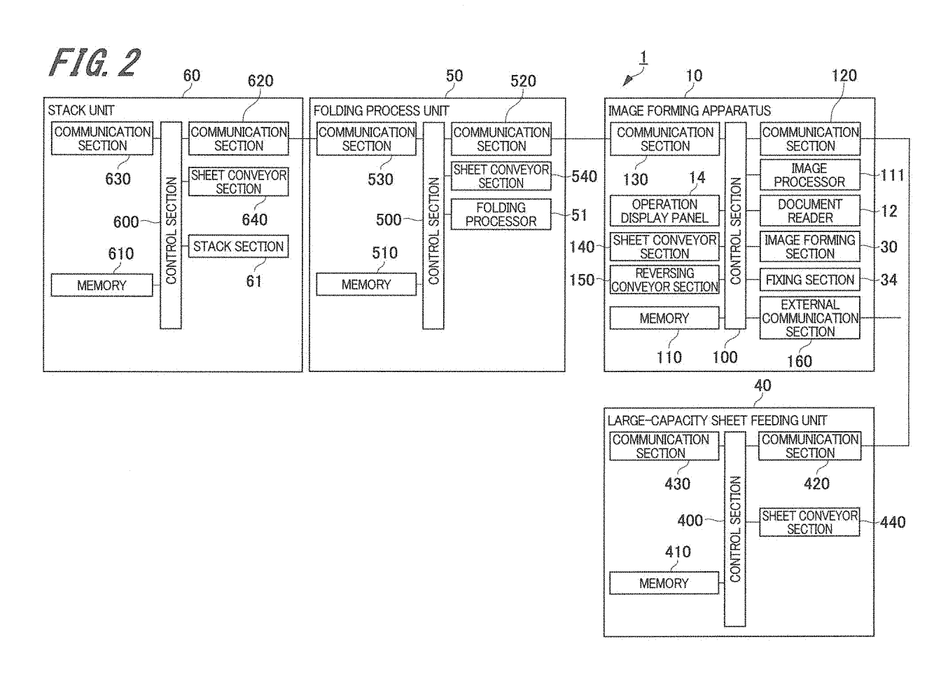

FIG. 2 is a block diagram showing an example of the control systems of the respective units constituting the image forming system 1.

### (Image Forming Apparatus)

The image forming apparatus 10 includes the operation display panel 14, the document reader 12, the image forming section 30, the fixing part 34, the control section 100, the memory 110, the sheet conveyor section 140, a reversing conveyor section 150, the communication sections 120, 130, and an external communication section 160. The control section 100 is connected to the respective sections so as to allow mutual data communication.

The control section 100 is constituted by an arithmetic processor, for example, CPU (Central Processing Unit) or MPU (Micro-Processing Unit). The control section 100 executes various control programs stored in the memory 110 to control operations of the respective sections in the image forming apparatus 10, and operations of the large-capacity sheet feeding unit 40, the folding process unit 50, and the stack unit 60. The control section 100 is configured to insert the folded partition sheet on which the index information is printed in between the output products of adjacent jobs, which have been collected on the collection tray 62.

The memory 110 is a volatile memory such as RAM, or a large-capacity nonvolatile memory. The memory 110 is used for retaining print setting information instructed through the operation display panel 14, read image data which have been read by the document reader 12, and the document data in addition to various control programs. For example, the memory 110 stores (1) program for re-arranging the order of outputting the retained job in accordance with the sheet size, and (2) program for folding the sheet under the preliminarily set condition. The program (2) may be stored in a memory 510 of the folding process unit 50.

An image processor 111 includes the arithmetic processor such as CPU, or an integrated circuit such as ASIC (Application Specific Integrated Circuit), and executes the process for generating electronic image data based on the electric signal sent from the document reader 12, and electronic data retained in the memory 110. The document reader 12 includes a sensor which reads optical information, and a function of converting the information such as images and characters printed on the paper medium into electric signals.

The image forming section 30 has functions of generating an electrophotograph corresponding to the electronic image data and the like generated by the image processor 111 through the electrographic process, and printing the electrophotograph on the recording medium such as the sheet S. The image forming section 30 executes the printing process to the sheet S based on the job to generate the output product under control of the control section 100, and prints the index information required to sort out the output products by each job on the partition sheet.

The communication section 120 is configured to transmit/receive data to/from the large-capacity sheet feeding unit 40. The communication section 130 is configured to transmit/receive data to/from the folding process unit 50. The external communication section 160 is configured to transmit/receive data to/from external devices (client terminal, mobile terminal, print controller, monitor server, and the like) via network. Upon reception of the job, the external communication section 160 transmits the job to the memory 110.

The sheet conveyor section 140 is a mechanism including a sheet feeding roller (not shown) which takes the sheet S from the sheet feed tray 20 for sheet feeding, and a conveyor roller (not shown) which conveys the sheet to the subsequent unit (folding process unit 50). The sheet conveyor section 140 conveys the sheet (sheet to be printed based on the job) designated by the job, and the partition sheet in between the jobs. The reversing conveyor section 150 is a mechanism including the reversing part 23, and reverses the sheet conveyed from the downstream side of the sheet conveyor section 140 so as to be returned to the upstream side of the sheet conveyor section 140.

The control section 100 controls operations of the sheet conveyor section 140, the image forming section 30, and the like based on the job input through the document reader 12 and the external communication section 160.

### (Large-Capacity Sheet Feeding Unit)

The large-capacity sheet feeding unit 40 includes a control section 400, a memory 410, communication sections 420, 430, and a sheet conveyor section 440.

The control section 400 constituted as the arithmetic processor, for example, CPU or MPU, controls operations of the respective sections in the large-capacity sheet feeding unit 40 based on the instruction of the control section 100 in the image forming apparatus 10. The memory 410 is the volatile memory such as RAM, or the large-capacity nonvolatile memory. The memory 410 stores the control program.

The communication section 420 is configured to transmit/receive data to/from the image forming apparatus 10, and further transmit/receive data to/from other units. Referring to FIG. 2, the communication section 430 is not connected to any other units. The sheet conveyor section 440 includes a not shown sheet feed roller and conveyor roller. The sheet conveyor section 440 picks up the sheet S from the sheet feed trays 41a to 41c, and conveys the picked-up sheet to the image forming apparatus 10. The sheet conveyor section 440 conveys the sheet designated by the job, and the partition sheet to be inserted in between adjacent jobs.

### (Folding Process Unit)

The folding process unit 50 includes a control section 500, a memory 510, communication sections 520, 530, a sheet conveyor section 540, and a folding processor 51.

The control section 500 constituted as the arithmetic processor, for example, CPU or MPU controls operations of the respective sections in the folding process unit 50 based on the instruction of the control section 100 in the image forming apparatus 10. The memory 510 is the volatile memory such as RAM, or the large-capacity nonvolatile memory. The memory 510 stores the control program. The folding processor 51 executes the predetermined folding process to the sheet S based on the instruction of the control section 500. The folding processor 51 is configured to allow the image forming section 30 of the image forming apparatus 10 to make a fold on the partition sheet on which the index information is printed in the predetermined region. The folding process to the sheet S by the folding processor 51 will be described in detail later.

The communication section 520 is configured to transmit/receive data to/from the image forming apparatus 10, and further transmit/receive data to/from the stack unit 60. The sheet conveyor section 540 includes a plurality of not shown conveyor rollers. The sheet conveyor section 540 receives the sheet from the preceding apparatus (image forming apparatus 10), and conveys the sheet to the subsequent unit (stack unit 60). The sheet conveyor section 540 conveys the sheet designated by the job, and the partition sheet to be inserted in between adjacent jobs.

### (Stack Unit)

The stack unit 60 includes a control section 600, a memory 610, communication sections 620, 630, a sheet conveyor section 640, and a stack section 61.

The control section 600 constituted as the arithmetic processor, for example, CPU or MPU controls operations of the respective sections in the stack unit 60 based on the instruction of the control section 100 in the image forming apparatus 10. The memory 610 is the volatile memory such as RAM, or the large-capacity nonvolatile memory. The memory 610 stores the control program. The stack unit 61 is configured to discharge the sheets S having the conveying path switched to the collection tray 62 by the switching part 64 based on the instruction of the control section 600.

The communication section 620 is configured to transmit/receive data to/from the folding process unit 50, and the communication section 630 is configured to transmit/receive data to/from the subsequently connected unit. Referring to FIG. 2, the subsequent unit is not connected to the communication section 630. The sheet conveyor section 640 includes a not shown conveyor roller. The sheet conveyor section 640 receives the sheet from the preceding unit (folding process unit 50), and discharges the sheet to the collection tray 62 or the discharge tray 63 in accordance with the job. The sheet conveyor section 640 conveys the sheet designated by the job, and the partition sheet to be inserted in between adjacent jobs.

The image forming apparatus 10, the large-capacity sheet feeding unit 40, the folding process unit 50, and the stack unit 60 mutually transmit and receive the status information of their own via the corresponding communication sections. The control sections of the respective units output the status information of their own to the other units. The status information includes, for example, the information of the operation state of each unit, the information of presence or absence of abnormality, and the information of content of the abnormality. The operation state of the unit is represented by the process information including the one indicating the page number of the job subjected to the sheet feeding and printing executed by the image forming apparatus 10, for example. The image forming apparatus 10 acquires the status information of the respective units in need, and reflects the acquired information in the instruction to the respective units.

### [Stacking of Output Products and Insertion of Partition Sheet]

Then, an example of stacking the output products and inserting the partition sheet according to the first embodiment will be described. The description will be made by exemplifying the case that the job is output in the order from the largest sheet size, and the resultant output products are stacked correspondingly.

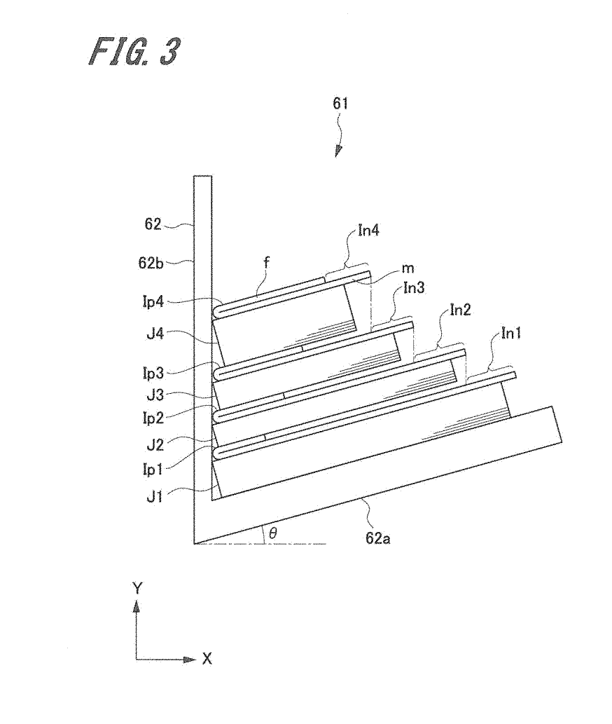

FIG. 3 is a front view of the stack section 61 for explaining an example of stacking the output products and inserting the partition sheets according to the first embodiment. As FIG. 3 shows, the stack section 61 includes a bottom 62a and a substantially plate-like abutment part 62b disposed vertical to the bottom 62a. The bottom 62a is slightly inclined to the horizontal direction (X-direction) at an angle θ. As the bottom 62a is slightly inclined at the angle θ, each edge of the output products and the partition sheets discharged to the collection tray 62 abuts on the abutment part 62b so that the front edge of the output product is aligned with a leading end of the two-folded partition sheet. The following explanation will be made on the assumption that the sheet conveying direction is set to X-direction, and the stacking direction (height direction) is set to Y-direction for convenience of explanation.

Referring to FIG. 3, output products of four jobs J1 to J4 are discharged to the bottom 62a of the collection tray 62 in the order from the largest sheet size. Each of partition sheets Ip1 to Ip4 is placed on each of the output products corresponding to the respective jobs J1 to J4. Each of the partition sheets Ip1 to Ip3 is inserted in between the output products of adjacent jobs among J1 to J4.

Each of the partition sheets Ip1 to Ip4 is folded in two by the folding process unit 50 along the fold made at the appropriate position. The fold (peak of the projected part) of each of the partition sheets Ip1 to Ip4 abuts on the abutment part 62b. Each of the two-folded partition sheets Ip has a main surface m in surface contact with the output product of the preceding job, and a fold-back surface f while facing with each other (bound state) via the fold. The control section 100 allows the folding processor 51 to designate each folding position of the partition sheets Ip1 to Ip4 so that at least a part of the index information printed on the partition sheets Ip1 to Ip4 each inserted in between the output products of adjacent jobs among J1 to J4 is visible from a predetermined direction (from above as shown in FIG. 3).

In order to stack the output products in the order from the largest sheet size, the print setting job for discharging the output product to the collection tray 62 is temporarily stored in the memory 110 and the like. As the output products are stacked in the order of the sheet size as described above, the advantageous effects may be obtained, that is, allowing confirmation of the index information from above, and preventing the output products from falling away upon stacking of differently sized output products of the respective jobs.

The image forming section 30 of the image forming apparatus 10 executes (image forming process) the multiple jobs (jobs J1 to J4 as shown in FIG. 3) from the largest sheet size, and generates the respective output products. The folding processor 51 of the folding process unit 50 folds the partition sheet in two based on the respective folding positions of the partition sheets Ip1 to Ip4 designated by the control section 100 so that each length of the main surfaces m including the index region In1 to In4, on which the index information of the partition sheets Ip1 to Ip4 is printed is equal to or longer than that of the output product of the precedingly processed job in the sheet conveying direction, and is equal to or shorter than that of the main surface m of the partition sheet just below the output product in the sheet conveying direction. The processed sheets are then discharged to the collection tray 62.

The above-described process allows visual confirmation of the index regions In1 to In4 on the respective main surfaces m of all the partition sheets Ip1 to Ip4 when viewing the output products finally collected on the collection tray 62 from above. In other words, the operator is capable of immediately confirming the index information list printed on the index regions In1 to In4 of the partition sheets Ip1 to Ip4 which have been inserted in between the output products of adjacent jobs among J1 to J4 from above.

### [Job Processing Procedure]

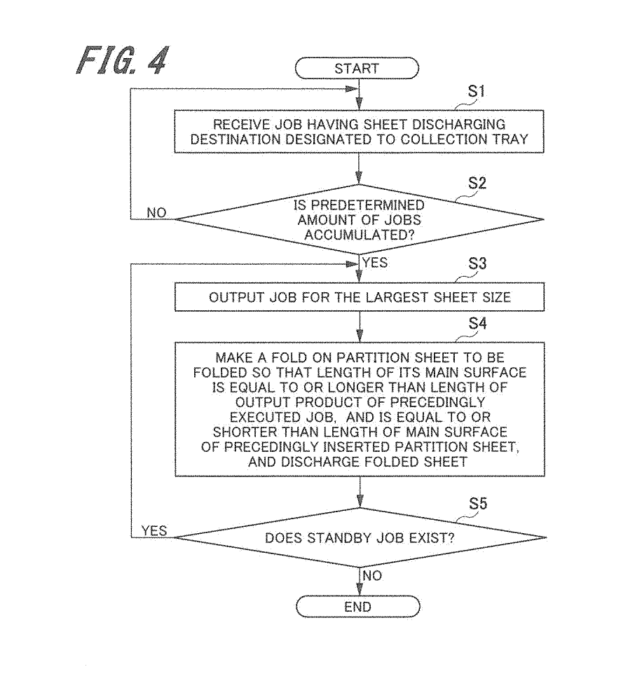

The job processing procedure including folding process and insertion of the partition sheet according to the first embodiment will be described. FIG. 4 is a flowchart representing an exemplified job processing procedure including the folding process and insertion of the partition sheet according to the first embodiment.

The control section 100 of the image forming apparatus 10 receives the job having the discharge destination designated to the collection tray 62 (S1), and temporarily stores the job in the memory 110. Then the control section 100 judges whether a predetermined amount of jobs have been accumulated (S2). If the predetermined amount of jobs has not been accumulated (NO in S2), the process returns to step S1, and continues reception of the job that satisfies the above-described condition. The term “predetermined amount of jobs” represents that the amount of jobs is equal to the given amount or more, or the total of the number of printed sheets of multiple jobs is equal to or larger than a threshold value.

Meanwhile, if the predetermined amount of jobs has been accumulated (YES in S2), the control section 100 outputs the job for the largest sheet size among the received jobs, and discharges the output product (see FIG. 3) of the job J1 to the collection tray 62 of the stack unit 60 (S3). Then the control section 100 allows the folding processor 51 of the folding process unit 50 to make the fold on the partition sheet Ip1 to be folded in two so that the length of the main surface m of the partition sheet Ip1 to be disposed on the output product of the job J1 discharged to the collection tray 62 in the sheet conveying direction (X-direction) is equal to or longer than the length of the precedingly generated output product of the job J1, and is equal to or shorter than the length of the main surface of the partition sheet just below the output product in the sheet conveying direction. In the case of the first partition sheet Ip1, there is no preceding partition sheet. The control section 100 then allows designation of the folding position of the partition sheet Ip1 so that the length of the main surface m of the partition sheet Ip1 in the sheet conveying direction (≈X-direction) is equal to or longer than the length of the precedingly generated output product of the job J1 in the sheet conveying direction.

The control section 100 conveys the partition sheet Ip1 which has been two-folded by the folding process unit 50 to the stack unit 60, and discharges the sheet on the output product of the job J1 on the collection tray 62 (S4).

The control section 100 judges whether or not the unexecuted job (standby job) exists in the memory 110 (S5). If the standby job exists (YES in S5), the process returns to step S3 where the job J2 which sets the second largest sheet size next to that of the preceding job J1, and the partition sheet Ip2 is output (steps S3 to S5 are executed repeatedly). Meanwhile, if all the jobs have been output, and no standby job exists (NO in S5), the process of the flowchart ends.

As FIG. 3 shows, the bottom 62a is inclined at the angle θ. However, it is possible to provide the bottom 62a in a horizontal plane (parallel to X-direction) without being inclined so as to provide the same effect as the one derived from the embodiment.

The method of generating the index without requiring the specific post-processor according to the first embodiment is capable of inserting the partition sheets each with the same size in between the output products of adjacent jobs, and forming the multiple indexes. The first embodiment is configured to allow the folding processor 51 to designate the folding position of the partition sheet so that at least a part of the index information printed on the respective partition sheets (main surfaces m according to the embodiment) inserted in between the output products of adjacent jobs is visible from a predetermined direction (from above in the embodiment). This ensures immediate visual confirmation of the index information list each printed on the partition sheets inserted in between the output products of adjacent jobs from above without requiring the specific post-processor. This allows the operator to easily sort out the discharged output products by the respective jobs through confirmation of the index information list.

### 2. Second Embodiment

A second embodiment exemplifies the case that the list of the index region In (index surface) where the index information is printed is visually confirmable when viewing the output products stacked on the collection tray 62 from the lateral side. The second embodiment will be described, taking the two-folding process of the partition sheet as an example.

### [Stacking of Output Products and Insertion of Partition Sheets]

FIG. 5 is a front view of the stack section for explaining an example of stacking the output products and inserting the partition sheets according to the second embodiment. Referring to FIG. 5, the respective output products of two jobs J1, J2 are discharged onto the bottom 62a of the collection tray 62, and each of partition sheets Ip11, Ip12 is disposed on the upper surface of the respective output products of the jobs J1, J2. The partition sheet Ip11 is inserted in between the output products of the adjacent jobs J1 and J2.

Each of the partition sheets Ip11, Ip12 is two-folded by the folding process unit 50 along the fold at the appropriate position. Each fold-back surface f of the respective partition sheets Ip11, Ip12 abuts on the abutment part 62b (in the surface contact state as shown in FIG. 5). The control section 100 allows the folding processor 51 to designate the respective folding positions of the partition sheets Ip11, Ip12 so that at least a part of the index information printed on the respective partition sheets Ip11, Ip12 disposed on the output products of the respective jobs J1, J2 is visually confirmable from the predetermined direction (from the (left) side as shown in FIG. 5).

The second embodiment allows setting of an arbitrary sheet size for the job. However, it is possible to configure the system to output jobs in the order from the largest sheet size, and to stack the resultant output products on the collection tray 62 likewise the first embodiment.

### [Two-Folding Process]

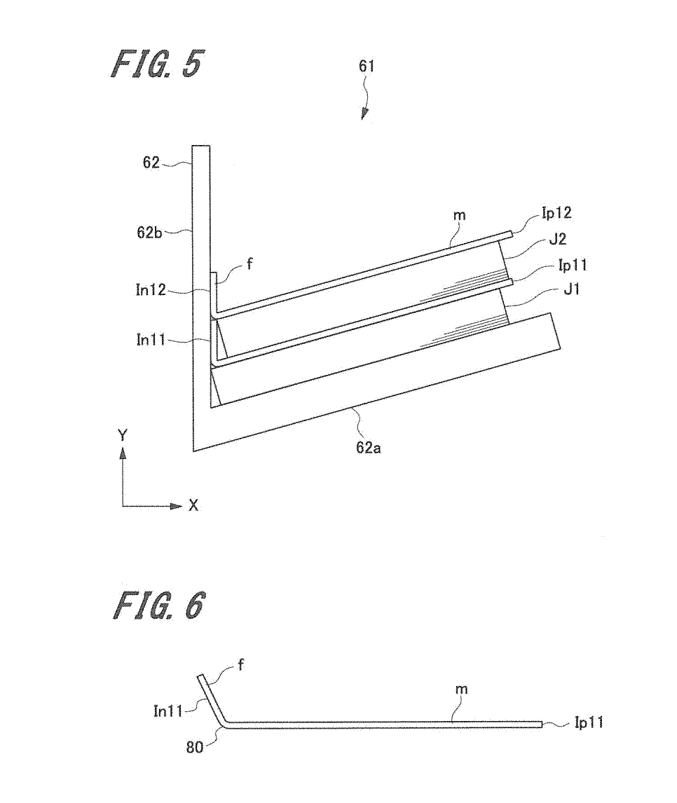

FIG. 6 is an explanatory view of the two-folding process to the partition sheet according to the second embodiment. Referring to FIG. 6, the explanation will be made, taking the partition sheet Ip11 as an example, which applies to the partition sheet Ip12.

Based on the folding position of the partition sheet Ip11 designated by the control section 100 of the image forming apparatus 10, the folding processor 51 of the folding process unit 50 makes a fold 80 on the partition sheet Ip11 with the force weaker than usual (for example, in the case of the two-folding process according to the first embodiment), along which the partition sheet Ip11 is two-folded. The usual folding includes the case that the post processing of folding is set for the job by the user (the folding process to the sheet S other than the one for index purpose) in addition to the case that the partition sheet is two-folded according to the first embodiment. The folding processor 51 discharges the two-folded partition sheet Ip11 to the collection tray 62 while having its recessed side upwardly positioned. As the fold 80 is made with weak force for the two-folded partition sheet Ip11, the main surface m and the fold-back surface having the index region In11 form an obtuse angle. The obtuse angle may be set so long as the object of the embodiment to be described later is achieved.

After the two-folded partition sheet Ip11 is discharged to the collection tray 62, the output products of the next job J2 are discharged to the collection tray 62. The output products of the next job J2 are disposed while being inserted into the recessed part of the two-folded partition sheet Ip11. The image forming section 30 prints the index information on the surface at the projected side of the fold-back surface f which is formed at the side opposite the main surface m of the partition sheet Ip11 in surface contact with the output product of the preceding job J1 via the fold 80.

As the fold 80 is made with weak force, the folded section of the two-folded partition sheet Ip11 will be opened upon its discharge to the collection tray 62. The fold-back part f as the folded side abuts on the abutment part 62b to be vertically raised (in Y-direction) in the same direction as the stacking direction of the output products guided by the abutment part 62b. The output products of the next job J2 discharged to the collection tray 62 may be disposed while being inserted into the recessed part of the two-folded partition sheet Ip11. The thus raised fold-back surface f (fold-up part) is used as the index surface (index region In) which allows printing of the index information.

Likewise the first embodiment, in the second embodiment, the index generation method requiring no specific post-processor allows the partition sheets each with the same size to be inserted in between the output products of adjacent jobs, and multiple indexes to be generated. In the second embodiment, the folding processor 51 is allowed to designate the folding position on the partition sheet so that at least a part of the index information printed on each of the fold-back surface f of the partition sheets inserted in between the output products of adjacent jobs is visually confirmable from the lateral side (left side in the embodiment). It is possible to visually confirm the index information list printed on the respective partition sheets inserted in between the output products of adjacent jobs from the lateral side immediately without requiring the specific post-processor. As a result, the operator is capable of easily sorting out the discharged output products of multiple jobs by confirming the index information list.

Unlike the first embodiment, in the above-described embodiment, the folding position for two-folding of the partition sheet does not have to be changed in accordance with the job sheet size. As there is no need of changing the folding position depending on change in the job sheet size, the arithmetic operation executed by the control section 100 may be simplified.

### 3. Third Embodiment

Likewise the second embodiment, a third embodiment exemplifies the case that the index region In (index surface) on which the index information is printed may be visually confirmable as the list when viewing the output products stacked on the collection tray 62 from the lateral side. The third embodiment describes an example of three-folding or Z-holding process to the partition sheet.

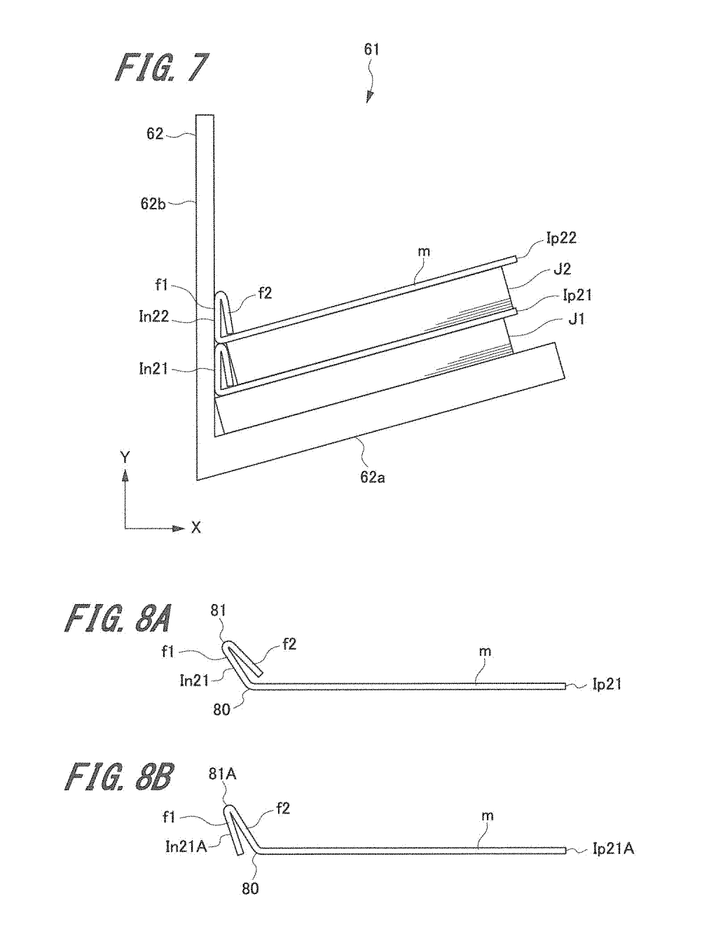

FIG. 7 is a front view of the stack section for explaining an example of stacking the output products and inserting the partition sheets according to the third embodiment. FIG. 7 is substantially the same as FIG. 5 except that the three-folding process is executed to the partition sheet instead of the two-folding process. In other words, referring to FIG. 7, the output products of two jobs J1, J2 are discharged onto the bottom 62a of the collection tray 62, and partition sheets Ip21, Ip22 are disposed on the corresponding output products of the jobs J1, J2, respectively. The partition sheet Ip21 is inserted in between the output products of the adjacent jobs J1 and J2.

Each of the partition sheets Ip21, Ip22 is three-folded by the folding process unit 50 along the fold at the appropriate position, having a first fold-back surface f1 (surface at the center of the three-folded sheet) in abutment on the abutment part 62b (in surface contact state as shown in FIG. 7). The control section 100 allows the folding processor 51 to designate each folding position of the partition sheets Ip21, Ip22 so that at least a part of the index information each printed on the partition sheets Ip21, Ip22 disposed on the output products of the jobs J1, J2 is visually confirmable from the predetermined direction (from the (left) side as shown in FIG. 7).

Likewise the second embodiment, the third embodiment allows setting of an arbitrary sheet size for the job. However, it is possible to configure the system to output jobs in the order from the largest sheet size, and to stack the resultant output products on the collection tray 62 likewise the first embodiment.

### [Three-Folding Process, Z-Folding Process]

The three-folding process and the Z-folding process will be described.

FIG. 8A and FIG. 8B are explanatory views of the folding process to the partition sheet according to the third embodiment. FIG. 8A represents the three-folding process, and FIG. 8B represents the Z-folding process. FIG. 8A and FIG. 8B show the partition sheet Ip21 as an example, which applies to the partition sheet Ip22.

As FIG. 8A shows, based on the folding position of the partition sheet Ip21, which has been designated by the control section 100 of the image forming apparatus 10, the folding processor 51 of the folding process unit 50 makes a first fold 80 constituting one side of the main surface m in surface contact with the output product of the preceding job on the partition sheet Ip21 with the force weaker than usual. The folding processor further makes a second fold 81 at the distal side from the main surface m of the partition sheet Ip21 with the force stronger than usual. The folding processor 51 executes the recess-folding process to the first fold-back surface f1 along the first fold 80 on the partition sheet Ip21 at the second fold 81 inward (to the side of the main surface m) so that the partition sheet Ip21 is three-folded. The three-folded partition sheet Ip21 is discharged to the collection tray 62 while having the recessed part at the first fold 80 upwardly positioned.

As the first fold 80 is made with weaker force on the three-folded partition sheet Ip21, the main surface m and the first fold-back surface f1 having the index region In21 form an obtuse angle. The obtuse angle may be set so long as the object of the embodiment to be described later is achieved.

After the three-folded partition sheet Ip21 is discharged to the collection tray 62, the output products of the next job J2 are discharged to the collection tray 62 while being inserted into the recessed part of the three-folded partition sheet Ip21, which has been formed along the first fold 80. The image forming section 30 prints the index information on the surface of the partition sheet Ip21 discharged to the collection tray 62, which is outwardly directed when viewing from the direction opposite the discharging direction (direction from the left to the right as shown in FIG. 7). In other words, in the case that the partition sheet Ip21 is three-folded as shown in FIG. 8A, the index information is printed on the projected surface of the first fold-back surface f1 of the partition sheet Ip21 at the side opposite the main surface m in surface contact with the output product of the preceding job J1 via the first fold 80.

The Z-folding process is substantially similar to the three-folding process. Specifically, as FIG. 8B shows, based on the folding position of a partition sheet Ip21A designated by the control section 100 of the image forming apparatus 10, the folding processor 51 of the folding process unit 50 makes the first fold 80 constituting one side of the main surface m in surface contact with the output product of the preceding job on the partition sheet Ip21A with the force weaker than usual. The folding processor further makes a second fold 81A at the distal side from the main surface m of the partition sheet Ip21A with the force stronger than usual. The folding processor 51 executes an outward project-folding process to the first fold-back surface f1 along the first fold 80 of the partition sheet Ip21A at the second fold 81A (the distal side from the main surface m) for executing the Z-folding process to the partition sheet Ip21A. The Z-folded partition sheet Ip21A is discharged to the collection tray 62 having the recessed part at the first fold 80 upwardly positioned.

In the case that the partition sheet Ip21A is Z-folded as shown in FIG. 8B, the index information is printed on the projected surface of the second fold-back surface f2 of the partition sheet Ip21A at the side opposite the first fold-back surface f1 via the second fold 81A at the distal side from the main surface m.

Likewise the second embodiment, the above-described third embodiment allows immediate visual confirmation of the index information list printed on the partition sheets each inserted in between the respective output products of adjacent jobs from the lateral side without requiring the specific post-processor.

### Fourth Embodiment

The second and the third embodiments as described above allow visual confirmation of the list of the index region In (index surface) when viewing the stacked output products from the lateral side. In the case of the small number of sheets to be printed for the next job, and inserted into the recessed part of the partition sheet (two-folded, three-folded, Z-folded), the problem as described below has to be taken into consideration. That is, there is a possibility that the index region In on the partition sheet Ip to be subsequently inserted and disposed on the printed sheet is concealed by the index region In on the partition sheet Ip which has been precedingly inserted at the lower side. Especially in the case that each minimum value of the length (height) of the fold-back surface f of the two-folded sheet, and the first fold-back surface f1 is limited owing to the mechanical specification of the folding processor 51, the possibility of causing the overlap problem as described above may be increased.

A fourth embodiment exemplifies the case for solving the (overlap) problem that confirmation of the information of the index region In on the upper partition sheet is disturbed by the lower partition sheet as described above. In this embodiment, the fold-back surface f of the two-folded sheet is further folded inward (three-fold), or outward (Z-fold) so as to make the length of the fold-up part (first fold-back surface f1) adjustable. The overlap problem which occurs in the three-folding or Z-folding process according to the third embodiment may be solved by adjusting the overlap ratio.

The control section 100 automatically adjusts the length of the surface of the partition sheet Ip to be precedingly inserted, on which the index information is printed so that the index information printed on the three-folded or Z-folded partition sheet Ip to be subsequently inserted is not completely concealed by the surface of the precedingly inserted partition sheet, on which the index information is printed.

Alternatively, based on the contents of the operator's input to the operation display panel 14, the control section 100 adjusts the length of the surface of the precedingly inserted partition sheet Ip, on which the index information is printed.

### [Two Partition Sheets in Overlap State]

An example of a state where two partition sheets are overlapped with each other will be described.

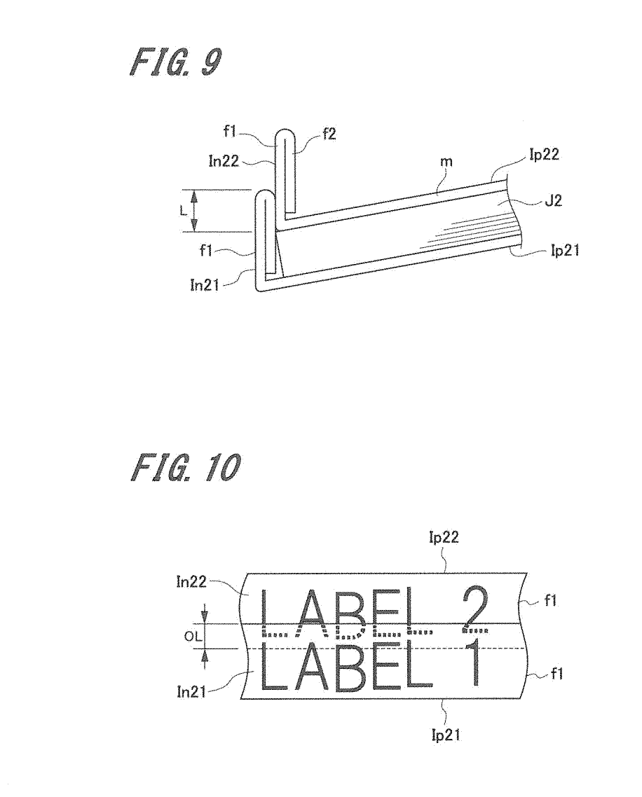

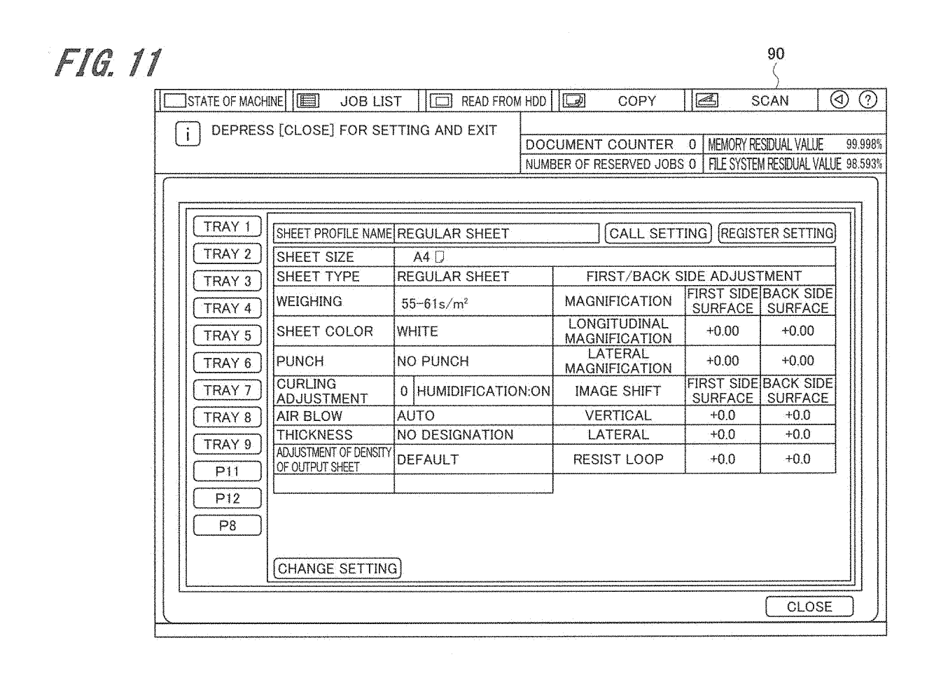

FIG. 9 shows an example of two partition sheets in the overlap state according to the fourth embodiment. FIG. 10 shows the index regions of the two overlapped partition sheets according to the fourth embodiment.

As FIG. 9 shows, after the partition sheet Ip21 is discharged, the output products of the job J2 are discharged. Then the partition sheet Ip22 is discharged onto the output product of the job J2. As FIG. 9 shows, the first fold-back surface f1 of the lower three-folded partition sheet Ip21 is overlapped with the first fold-back surface f1 of the upper three-folded partition sheet Ip22.

In the above-described state, a part of the information “Label 2” printed on the index region In22 of the first fold-back surface f1 of the upper partition sheet Ip22 is concealed by the first fold-back surface f1 of the lower partition sheet Ip21 as shown in FIG. 10. If the length of an overlapped part OL becomes long, or the ratio of the length of the overlapped part OL to the length of the first fold-back surface f1 of the upper partition sheet Ip22 becomes large, there may cause the risk of interrupting confirmation of the index information, resulting in interference with the operations for sorting out the output products for the respective jobs.

In this embodiment, the operator sets the length of the first fold-back surface f1 (fold-up part) of the lower partition sheet to an adjustable value through the operation display panel 14. It is preferable to preliminarily evaluate the value to be set, and store such a value in the memory 110. For example, the allowable overlap ratio between the partition sheets may be set by determining the position (upper limit in terms of percentage) of the leading end of the first fold-back surface f1 of the partition sheet to be folded relative to the height of the first fold-back surface f1 (index region) of the subsequently inserted partition sheet.

FIG. 11 shows an example of a sheet setting screen 90. The sheet (sheet type, sheet size, weighing) to be used for printing is set for each job. The tray for feeding the sheet is determined in accordance with setting of the sheet for the job. The information of the sheet setting for the job is stored in the memory 110.

It is possible to preliminarily calculate the height of the output products from the sheet setting for the next job (sheet size, weighing) and the number of printing sheets. The height of the output products generated by the job may be obtained by integrating the thickness of each sheet derived from weighing by the number of printing sheets. The control section 100 may be configured to automatically determine the length (or overlap ratio) of the first fold-back surface f1 of the partition sheet to be folded based on the height of the output products of the next job, or the information of the height of the output products of the next job and the index region (index information) on the next partition sheet.

It is also possible to confirm the index information by adjusting the position, size, number of lines of the index information (for example, characters, graphics, images and the like) to be printed on the index region instead of the length of the overlap part OL and the overlap ratio. This makes it possible to indirectly solve the overlap problem.

### [Job Processing Procedure]

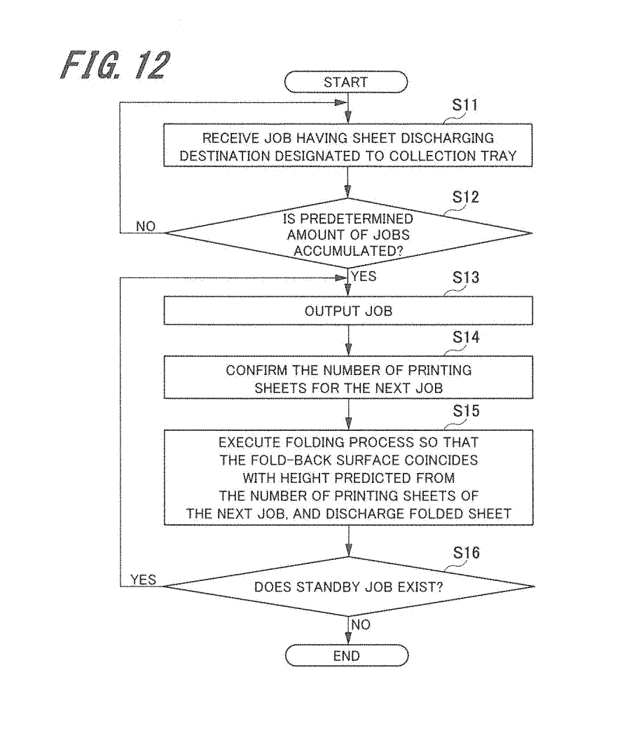

The job processing procedure including the folding process and insertion of the partition sheet according to the fourth embodiment will be described. FIG. 12 is a flowchart representing an example of the job processing procedure including the folding process and insertion of the partition sheet according to the fourth embodiment.

The control section 100 of the image forming apparatus 10 receives the job having the discharge destination designated to the collection tray 62 (S11), and temporarily stores the job in the memory 110. Then the control section 100 judges whether a predetermined amount of jobs have been accumulated (S12). If the predetermined amount of jobs has not been accumulated (NO in S12), the process returns to step S11, and continues reception of the job that satisfies the above-described condition.

If the predetermined amount of jobs has been accumulated (YES in S12), the control section 100 outputs the jobs retained in the memory 110 in the order of reception, and discharges the output products of the job J1 (see FIG. 7, FIG. 9) to the collection tray 62 of the stack unit 60 (S13).

Then the control section 100 confirms the number of printed sheets based on the print setting for the next job J2 (S14). The control section 100 determines the height of the fold-up part of the partition sheet Ip21 to be disposed on the output product of the job J1 (first fold-back surface f1) so that such height coincides with the height predicted from the number of printed sheets of the next job J2, and further determines the folding position of the partition sheet Ip21 (S15). The folding processor 51 of the folding process unit 50 executes the three-folding process or Z-folding process to the partition sheet Ip21 along the folding position determined by the control section 100, and discharges the folded partition sheet to the collection tray 62. In this case, the control section 100 may be configured to allow manual determination of the height of the fold-up part in accordance with the operator's instruction via the operation display panel 14.

The control section 100 judges whether or not the unexecuted job (standby job) exists in the memory 110 (S16). If the standby job exists (YES in S16), the process returns to step S13 for executing the process steps from S13 to S16. Meanwhile, if all the jobs have been output, and the standby job does not exist (NO in S16), the control section 100 ends execution of the process of the flowchart.

If the number of printing sheets for the next job, which will be inserted into the recessed part of the corresponding partition sheet (two-folded, three-folded, Z-folded) is small, the above-described fourth embodiment is capable of avoiding or minimizing the influence of the problem of overlap between the index region In21 on the partition sheet Ip21 to be inserted at the lower side and the index region In22 on the partition sheet Ip22 to be inserted at the upper side. Likewise the second and the third embodiments, the fourth embodiment allows immediate confirmation of the index information list printed on the partition sheets to be inserted in between the respective output products of adjacent jobs from the lateral side without requiring the specific post-processor. This allows the operator to easily sort out the discharged output products of the multiple jobs by confirming the index information list.

The present invention may be arbitrarily applied or modified in various ways without being limited to the above-described embodiments so long as it does not deviate from the scope of the present invention in the appended claims.

In the above-described embodiments, structures of the apparatus and the system have been described in detail referring to embodiments for easy understanding of the present invention. They do not necessarily have to include all the components as described above. It is possible to replace a part of the structure of one embodiment with the structure of another embodiment. The above-described one embodiment may be provided with an additional component of another embodiment. It is further possible to add, remove, and replace the other component to, from and with a part of the structure of the respective embodiments.

The respective components, functions, processors and the like may be realized through hardware by designing those constituent elements partially or entirely using the integrated circuit. The respective components and functions may also be realized through software by interpreting and executing the program that allows the processor to implement the respective functions. Information of the program, table, file and the like for implementing the respective functions may be stored in the recording device such as the memory, hard disk, and SSD (Solid State Drive), or a recording medium such as IC card, SD card, and DVD.

### REFERENCE SIGNS LIST

1 image forming system
10 image forming apparatus
30 image forming section
40 large-capacity sheet feeding unit
50 folding process unit
51 folding processor
60 stack unit
61 stack section
62 collection tray
62a bottom
62b abutment part
70 post-processor
80 fold (first fold)
81, 81A second fold
90 sheet setting screen
100 control section
140 sheet conveyor section
500, 600 control section
540, 640 sheet conveyor section
J1-J4 job
Ip1-Ip4, Ip11-Ip12, Ip11A, Ip21-Ip22 partition sheet
In1-In4, In11-In12, In11A, In21-In22 index region
m main surface
f fold-back surface
f1 first fold-back surface
f2 second fold-back surface
OL overlapped part

What is claimed is:

1. An image forming system comprising:
a conveyor section for conveying a sheet on which a printing process for forming an image is executed based on a job, and conveying a partition sheet in between the jobs;
an image forming section for generating an output product by executing the printing process to the sheet based on the job, and printing index information required for sorting the output products for the respective jobs on the partition sheet;
a folding process unit capable of making a fold on the partition sheet on which the index information has been printed by the image forming section;
a collection tray disposed at a downstream side of the folding process unit in a sheet conveying direction, which is capable of collecting the output products of the jobs generated by the image forming section; and
a control section configured to insert the folded partition sheet, on which the index information has been printed in between the output products of the respective jobs to be collected to the collection tray,
wherein the control section allows the folding process unit to designate a folding position of the partition sheet so that at least a part of the index information printed on the respective partition sheets each inserted in between the output products of the respective jobs is visible from a predetermined direction.

2. The image forming system according to claim 1, wherein:
the image forming section generates the output products by processing the jobs in the order from the largest size of the sheet used for the job; and
based on the folding position of the partition sheet designated by the control section, the folding process unit makes a fold along which a two-folding process is executed to the partition sheet so that a length of a main surface of the partition sheet, which includes an index region on which the index information has been printed while being in surface contact with the output product of a preceding job is equal to or longer than a length of the precedingly generated output product of the job in the sheet conveying direction, and is equal to or shorter than a length of a main surface of the partition sheet just below the output product in the sheet conveying direction, and the folded partition sheet is discharged to the collection tray.

3. The image forming system according to claim 1, wherein:
based on the folding position of the partition sheet designated by the control section, the folding process unit makes a fold on the partition sheet with force weaker than usual, and folds the partition sheet in two, which is discharged to the collection tray while having a recessed side upwardly positioned; and
when the two-folded partition sheet is discharged to the collection tray, and the output product of the next job is subsequently discharged to the collection tray, the output product of the next job is disposed while being inserted into a recessed part of the two-folded partition sheet, and the image forming section prints the index information on a projected side surface of a fold-back surface of the partition sheet at a side opposite the main surface in surface contact with the output product of the preceding job via the fold.

4. The image forming system according to claim 1, wherein:
based on the folding position of the partition sheet designated by the control section, the folding process unit makes a first fold constituting one side of a main surface of the partition sheet in surface contact with the output product of the preceding job with force weaker than usual, and makes a second fold at a distal side from the main surface of the partition sheet with force stronger than usual so that the partition sheet is three-folded or Z-folded, which is discharged to the collection tray while having a recessed side upwardly positioned; and
when the three-folded or the Z-folded partition sheet is discharged to the collection tray, and the output product of the next job is subsequently discharged to the collection tray, the output product of the next job is disposed while being inserted into a recessed part formed by the first fold on the three-folded or the Z-folded partition sheet, and the image forming section prints the index information on a surface to be outwardly directed when viewing the partition sheet discharged to the collection tray from a direction opposite a sheet discharging direction.

5. The image forming system according to claim 4, wherein:
if the partition sheet is three-folded, the index information is printed on a surface of a projected side of a first fold-back surface formed at a side opposite the main surface of the partition sheet in surface contact with the output product of the preceding job via the first fold; or
if the partition sheet is Z-folded, the index information is printed on a surface of a projected side of a second fold-back surface formed at a side opposite the first fold-back surface of the partition sheet via the second fold.

6. The image forming system according to claim 3, wherein the control section adjusts a length of a surface of the partition sheet to be precedingly inserted, on which the index information is printed so that the index information printed on the three-folded or the Z-folded partition sheet to be subsequently inserted is not completely concealed by the surface of the precedingly inserted partition sheet, on which the index information has been printed.

7. The image forming system according to claim 6, further comprising an operation unit which receives a user's input,
wherein based on a content of the user's input to the operation unit, the control section adjusts the length of the surface of the precedingly inserted partition sheet on which the index information is printed.

8. A post-processor used for an image forming system including an image forming section for executing a printing process to a sheet based on a job to generate an output product, and printing index information required for sorting the output products for each job on a partition sheet, the post-processor comprising:
a conveyor section for conveying the sheet on which the printing process for forming an image is executed based on the job, and conveying the partition sheet in between the jobs;
an folding process unit capable of making a fold on the partition sheet on which the index information has been printed by the image forming section;
a collection tray disposed at a downstream side of the folding process unit in a sheet conveying direction, which is capable of collecting the output products of the jobs generated by the image forming section; and
a control section configured to insert the folded partition sheet on which the index information has been printed in between the output products of the respective jobs collected on the collection tray,
wherein the control section allows the folding process unit to designate a folding position of the partition sheet so that at least a part of the index information printed on the respective partition sheets each inserted in between the output products of the respective jobs is visible from a predetermined direction.

9. A computer readable recording medium storing a program, the program causing a computer provided in an image forming system for generating output products for each job, and inserting a partition sheet in between the output products of the respective jobs to perform:
conveyance step of conveying a sheet on which a printing process for forming an image is executed based on the job, and conveying the partition sheet in between the respective jobs;
image forming step of generating the output product by executing the printing process to the sheet based on the job, and printing index information required for sorting the output products for the respective jobs on the partition sheet;
folding process step of making a fold by using a folding process unit on the partition sheet on which the index information has been printed in the image forming step;
collection step of collecting the output products of the respective jobs generated in the image forming step to a collection tray disposed at a downstream side of the folding process unit in a sheet conveying direction; and
control step of controlling so that the folded partition sheet on which the index information has been printed is inserted in between the output products of the respective jobs, which are collected to the collection tray,
wherein the control step further includes a step of allowing the folding process unit to designate a folding position of the partition sheet so that at least a part of the index information printed on the respective partition sheets each inserted in between the output products of the respective jobs is visible from a predetermined direction.
